(19) United States
(12) Patent Application Publication
(10) Pub. No.: US 2020/0284602 A1
(43) Pub. Date: Sep. 10, 2020

(54) COMPUTERIZED VEHICLE DELIVERY COORDINATION

(71) Applicant: ValetU Inc., Midway, UT (US)

(72) Inventors: Andrew Larson, Midway, UT (US); J. Wade Kelson, Midway, UT (US)

(73) Assignee: ValetU Inc., Midway, UT (US)

(21) Appl. No.: 16/297,497

(22) Filed: Mar. 8, 2019

(51) Int. Cl. G01C 21/34

(52) U.S. Cl. CPC G01C 21/3484

(57) ABSTRACT

Computerized data regarding a driving event can be received from a computerized driving coordination service, with the data regarding the driving event including a primary starting location. The computerized data regarding the driving event can be presented to a primary driver profile. In addition, computerized data regarding a secondary driving event that is linked in a computer system with the primary driving event and a secondary driver profile can be received for the primary driver profile. The computerized data regarding the secondary driving event can include a geographic secondary starting location and a geographic secondary ending location, wherein the secondary ending location can be proximate to the primary starting location.

### BACKGROUND

Computerized systems for coordinating passenger rides often involve the computer system coordinating a ride event between a single passenger profile in the system and a single driver profile in the system. The computerized coordination can include connecting the passenger profile with a selected driver profile to coordinate the driver profile giving the user profile a ride to a specified location. The computerized coordination may track the locations of the driver profile (via a driver computing device) during all or part of a passenger driving event.

Personal driver services exist, which include a driver performing vehicle delivery services, such as valet or chauffer-type services for users using a vehicle provided by the user (such as the user's own vehicle). Such services can include mobile applications for users that can perform various functions for users and/or drivers using their mobile devices, such as smartphones.

### SUMMARY

Whatever the advantages of previous vehicle delivery tools and techniques, they have neither recognized the computerized vehicle delivery coordination tools and techniques described and claimed herein, nor the advantages produced by such tools and techniques. For example, it has been found that computer systems that support vehicle delivery services (where requesting users provide the vehicles to be driven) are either lacking in functionality, or they require manual input in performing at least some of the functionality, such as coordinating user profiles to provide rides to bring drivers to starting locations before performing vehicle deliveries and/or to bringing drivers back from destination locations after vehicle deliveries. The tools and techniques discussed herein can provide an improved vehicle delivery coordination system that can provide improved features, improved operating efficiency, improved usability, and/or improved automated features as compared to previous systems.

In one aspect, the tools and techniques can include, in response to receiving user input via a user application running for a requesting user profile, generating a computer-readable request for a vehicle driving connection to a vehicle driver profile of a plurality of vehicle driver profiles, with the drive request specifying a geographic primary starting location. In response to the request for the vehicle driving connection, a connection between the requesting user profile and a primary driver profile can be generated in a computer-readable drive record that represents a vehicle delivery event in the computer system. The generating of the connection between the requesting user profile and the primary driver profile can include processing computerized data regarding the primary starting location and a secondary starting location, which can be a geographic location connected with the primary driver profile in the computer system. A computer-readable confirmation can be sent to the requesting user profile on the user computing device, with the confirmation to the requesting user profile confirming the connection between the requesting user profile and the primary driver profile. Computerized data regarding the primary starting location can be presented to the primary driver profile on a primary driver computing device in the computer system. A computer-readable connection between the primary driver profile and a computer-readable secondary driver profile can be generated in the drive record. The generating of the connection between the primary driver profile and the secondary driver profile can include processing computerized data regarding the secondary starting location and computerized data regarding a geographic location connected with the secondary driver profile in the computer system. Computerized data regarding the secondary starting location can be sent to the secondary driver profile. Additionally, a computer-readable confirmation can be presented to the primary driver profile on the primary driver computing device, with the confirmation confirming the connection between the requesting user profile and the primary driver profile.

In another aspect, the tools and techniques can include receiving a computer-readable drive request from a user profile of a plurality of user profiles for a vehicle driving connection to a vehicle driver profile of a plurality of vehicle driver profiles, with the drive request specifying a geographic primary starting location. In response to the receiving of the request, the technique can include generating a computer-readable connection between the requesting user profile and a primary driver profile of a plurality of driver profiles. The generating of the connection between the requesting user profile and the primary driver profile can include processing computerized data regarding the primary starting location and a secondary starting location, wherein the secondary starting location can be a geographic location connected with the primary driver profile in the computer system. A computer-readable confirmation can be sent to the requesting user profile, confirming the connection between the requesting user profile and the primary driver profile. Computerized data regarding the primary starting location can be sent to the primary driver profile. In response to the generating of the connection between the requesting user profile and the primary driver profile, a computer-readable connection between the primary driver profile and a computer-readable secondary driver profile can be generated. The generating of the connection between the primary driver profile and the secondary driver profile can include processing computerized data regarding the secondary starting location and computerized data regarding a geographic location connected with the secondary driver profile in the computer system. Computerized data regarding the secondary starting location can be sent to the secondary driver profile. Moreover, in response to the generating of the connection between the requesting user profile and the primary driver profile, a computer-readable confirmation can be sent to the primary driver profile, confirming the connection between the requesting user profile and the primary driver profile. Additionally, in response to the generating of the connection between the primary driver profile and the secondary driver profile, a computer-readable confirmation can be sent to the primary driver profile confirming the connection between the primary driver profile and the secondary driver profile.

In yet another aspect of the tools and techniques, computerized data regarding a driving event can be received from a computerized driving coordination service, with the computerized data regarding the driving event including a primary starting location. The computerized data regarding the driving event can be presented to the primary driver profile. An acceptance user interface control that is selectable to accept a computerized connection of the primary driver profile with the driving event can be presented. A user input selection of the acceptance user interface control can be received. In response to the selection of the acceptance user interface control, acceptance data that is responsive to the receiving of the computerized data regarding the driving event can be sent to the computerized driving coordination service. In addition, computerized data regarding a secondary driving event that is linked in the application with the primary driving event can be received for the primary driver profile. The computerized data regarding the secondary driving event can include a geographic secondary starting location and a geographic secondary ending location, wherein the secondary ending location can be proximate to the primary starting location.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described aspects may be implemented.

FIG. 2 is schematic diagram of a vehicle delivery coordination system.

FIG. 3 is a schematic diagram of a primary driving coordination service.

FIG. 4 is an illustration of a client device running a requesting user application.

FIG. 5 is an illustration of a client device running a primary driver application.

FIG. 6 is another illustration of the client device of FIG. 5.

FIG. 7 is a flowchart of a computerized vehicle delivery coordination technique.

FIG. 8 is a flowchart of another computerized vehicle delivery coordination technique.

FIG. 9 is a flowchart of yet another computerized vehicle delivery coordination technique.

### DETAILED DESCRIPTION

Aspects described herein are directed to techniques and tools for improved computerized vehicle delivery coordination for personal driver services. Such improvements may result from the use of various techniques and tools separately or in combination.

Such techniques and tools may include computing device applications that are part of a computer system that can arrange for or coordinate vehicle delivery from one place to another. Such a vehicle can be delivered to/for the person arranging. Or it may be a delivery between individuals and/or businesses. The delivery may include chauffer service with a requesting passenger in the car with the driver. For example, the delivery could be picking up the person's car when they are at the airport going on a trip (one delivery) and delivering it to them again at the airport when they get back (a second delivery). It could be delivering it from one person/business to another person/business. For example, a requesting user may ask through the application for their car to be delivered from the airport to a parking garage when they leave on a trip, and then delivered from the parking garage back to the airport when they return. And it may be for some specified purpose—such as to get an oil change or some other service on the car. If it was for a service such as an oil change, it could be up to the requesting user to arrange payment of the business (auto shop, etc.) ahead of time. However, the requesting user could specify the service by providing user input through the application, and data for that specification of a service can be saved in a drive record and sent to a primary driver profile via a computer application running for the primary driver profile.

In use, a requesting user with the application running on their device can enter the car delivery information through user input to the application. This delivery information can include a starting address and may include a destination address for the delivery. It can also include contact information for the starting address and destination address (such as contact information for a business or individual). The delivery information may also specify a service to be performed on the vehicle at the destination. This information can be uploaded to a server and can be provided to a primary driver profile on a device operated for a primary driver that is to drive a vehicle provided by the requesting user. The requesting user can also provide payment for the delivery service through the application and the associated computer system.

The server can use the delivery information to arrange for a driver to drive the client's vehicle, such as by connecting a user profile of the requesting user with a user profile of the driver in a drive record and providing operations such as sending data regarding the drive event to the connected user profiles. This can include identifying a user profile for a driver that is available, and it may include considering factors such as the proximity of the driver to the starting address for the delivery. The server can also arrange for transportation of the driver to the starting address (such as from the driver's home to the starting address), and transportation of the driver away from the destination address (such as back to the driver's home). This transportation may be arranged with an individual driver that is contracted with the entity running this system, or it may be arranged through some other third-party transportation service, such as through a taxi service, or through a transportation service wherein drivers use their own vehicles for driving passengers. The server system can provide payment to the third-party transportation service.

The system can also provide notifications through the user application, such as notifying the client when their vehicle is delivered to a destination or giving an estimated time of arrival of the driver at the starting location, or arrival of their vehicle at the destination location. The system may also provide the location of the requesting user's vehicle, so that a user can track the location using the application (this can be done using a third-party mapping service through the user application, for example). Additionally, the system can provide the requesting user with information about the driver through the user application, such as reviews of the driver, the driver's picture, and so forth.

In performing the coordination of vehicle deliveries, the computer system can generate connections between requesting user profiles and driver profiles, which can be recorded in drive records for driving events. For example, a connection may be made between a requesting user profile (which is requesting a vehicle delivery) and a primary driver profile (which can be connected with the delivery and may be associated with a driver that will drive the vehicle). The system may also make connections with one or more other driver profiles that can be associated with drivers that deliver the primary driver to a starting location for the vehicle delivery and/or pick up the primary driver from a destination location for the vehicle delivery. The connections can be connections in a computer system, such as data entries in user profiles and/or drive records. Using the tools and techniques discussed herein related to making such connections with the computer system in response to other computerized acts can provide substantial benefits beyond prior systems that did not provide such features and/or required manual actions to be performed.

As used herein, a user profile (which can include a driver profile) is a set of data that represents an entity such as a user, a group of users, a computing resource, etc. When references are made herein to a user profile performing actions (sending, receiving, etc.), those actions are considered to be performed by a user profile if they are performed by computer components in an environment where the user profile is active (such as where the user profile is logged into an environment and that environment controls the performance of the actions). Often such actions by or for a user profile are also performed by or for a user corresponding to the user profile. For example, this may be the case where a user profile is logged in and active in a computer application and/or a computing device that is performing actions for the user profile on behalf of a corresponding user. To provide some specific examples, this usage of terminology related to user profiles applies with references to a user profile providing user input, receiving responses, or otherwise interacting with computer components discussed herein.

Accordingly, one or more substantial benefits can be realized from the vehicle delivery coordination tools and techniques described herein. For example, the tools and techniques discussed herein can facilitate greater automation in coordinating vehicle deliveries and can provide additional features that can make the computer system more useful and efficient. For example, by providing greater automation, the system can reduce wasted use of some computer resources (such as wasted resources in handling telephone calls, email messages, and/or text messages to arrange for drivers, when more efficient connections between different drivers and/or between drivers and requesting users can be performed using the tools and techniques discussed herein). Such added automation and features can also make the system more user-friendly, such as by reducing the time that users would otherwise spend in coordinating vehicle rides without such automation features. Accordingly, the tools and techniques discussed herein can provide an improved vehicle delivery coordination system.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

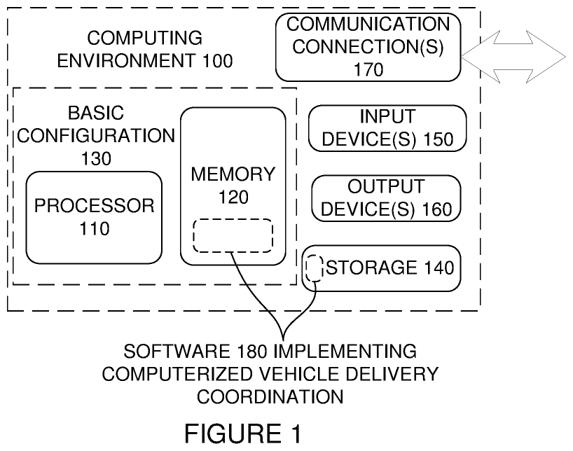

Techniques described herein may be used with one or more of the systems described herein and/or with one or more other systems. For example, the various procedures described herein may be implemented with hardware or software, or a combination of both. For example, the processor, memory, storage, output device(s), input device(s), and/or communication connections discussed below with reference to FIG. 1 can each be at least a portion of one or more hardware components. Dedicated hardware logic components can be constructed to implement at least a portion of one or more of the techniques described herein. For example, and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various aspects can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionalities, as described herein.

### I. Exemplary Computing Environment

FIG. 1 illustrates a generalized example of a suitable computing environment 100 in which one or more of the described aspects may be implemented. For example, one or more such computing environments can be used as a service, system, and or computing device in a vehicle coordination computer system. Generally, various computing system configurations can be used. Examples of computing system configurations that may be suitable for use with the tools and techniques described herein include, but are not limited to, server farms and server clusters, personal computers, server computers, smart phones, laptop devices, slate devices, game consoles, multiprocessor systems, microprocessor-based systems, programmable consumer electronics, network PCs, minicomputers, mainframe computers, distributed computing environments that include any of the above systems or devices, and the like.

The computing environment 100 is not intended to suggest any limitation as to scope of use or functionality of the invention, as the present invention may be implemented in diverse types of computing environments.

With reference to FIG. 1, various illustrated hardware-based computer components will be discussed. As will be discussed, these hardware components may store and/or execute software. The computing environment 100 includes at least one processing unit or processor 110 and memory 120. In FIG. 1, this most basic configuration 130 is included within a dashed line. The processing unit 110 executes computer-executable instructions and may be a real or a virtual processor. In a multi-processing system, multiple processing units execute computer-executable instructions to increase processing power. The memory 120 may be volatile memory (e.g., registers, cache, RAM), non-volatile memory (e.g., ROM, EEPROM, flash memory), or some combination of the two. The memory 120 stores software 180 implementing computerized vehicle delivery coordination. An implementation of computerized vehicle delivery coordination may involve all or part of the activities of the processor 110 and memory 120 being embodied in hardware logic as an alternative to or in addition to the software 180.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component (e.g., if the display device includes a touch screen). Also, processors have memory. The inventors hereof recognize that such is the nature of the art and reiterate that the diagram of FIG. 1 is merely illustrative of an exemplary computing device that can be used in connection with one or more aspects of the technology discussed herein. Distinction is not made between such categories as “workstation,” “server,” “laptop,” “handheld device,” etc., as all are contemplated within the scope of FIG. 1 and reference to “computer,” “computing environment,” or “computing device.”

A computing environment 100 may have additional features. In FIG. 1, the computing environment 100 includes storage 140, one or more input devices 150, one or more output devices 160, and one or more communication connections 170. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The memory 120 can include storage 140 (though they are depicted separately in FIG. 1 for convenience), which may be removable or non-removable, and may include computer-readable storage media such as flash drives, magnetic disks, magnetic tapes or cassettes, CD-ROMs, CD-RWs, DVDs, which can be used to store information and which can be accessed within the computing environment 100. The storage 140 stores instructions for the software 180.

The input device(s) 150 may be one or more of various input devices. For example, the input device(s) 150 may include a user device such as a mouse, keyboard, trackball, etc. The input device(s) 150 may implement one or more natural user interface techniques, such as speech recognition, touch and stylus recognition, recognition of gestures in contact with the input device(s) 150 and adjacent to the input device(s) 150, recognition of air gestures, head and eye tracking, voice and speech recognition, sensing user brain activity (e.g., using EEG and related methods), and machine intelligence (e.g., using machine intelligence to understand user intentions and goals). As other examples, the input device(s) 150 may include a scanning device; a network adapter; a CD/DVD reader; or another device that provides input to the computing environment 100. The output device(s) 160 may be a display, printer, speaker, CD/DVD-writer, network adapter, or another device that provides output from the computing environment 100. The input device(s) 150 and output device(s) 160 may be incorporated in a single system or device, such as a touch screen or a virtual reality system.

The communication connection(s) 170 enable communication over a communication medium to another computing entity. Additionally, functionality of the components of the computing environment 100 may be implemented in a single computing machine or in multiple computing machines that are able to communicate over communication connections. Thus, the computing environment 100 may operate in a networked environment using logical connections to one or more remote computing devices, such as a handheld computing device, a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment 100, computer-readable storage media include memory 120, storage 140, and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular data types. The functionality of the program modules may be combined or split between program modules as desired in various aspects. Computer-executable instructions for program modules may be executed within a local or distributed computing environment. In a distributed computing environment, program modules may be in both local and remote computer storage media.

For the sake of presentation, the detailed description uses terms like “determine,” “choose,” “adjust,” “generate,” and “operate” to describe computer operations in a computing environment. These and other similar terms are high-level descriptions for operations performed by a computer and should not be confused with acts performed by a human being, unless performance of an act by a human being (such as a “user”) is explicitly noted. The actual computer operations corresponding to these terms vary depending on the implementation.

### II. Computerized Vehicle Delivery Coordination System and Environment

Communications between the various devices and components discussed herein can be sent using computer system hardware, such as hardware within a single computing device, hardware in multiple computing devices, and/or computer network hardware. A communication or data item may be considered to be sent to a destination by a component if that component passes the communication or data item to the system in a manner that directs the system to route the item or communication to the destination, such as by including an appropriate identifier or address associated with the destination. Also, a data item may be sent in multiple ways, such as by directly sending the item or by sending a notification that includes an address or pointer for use by the receiver to access the data item. In addition, multiple requests may be sent by sending a single request that requests performance of multiple tasks.

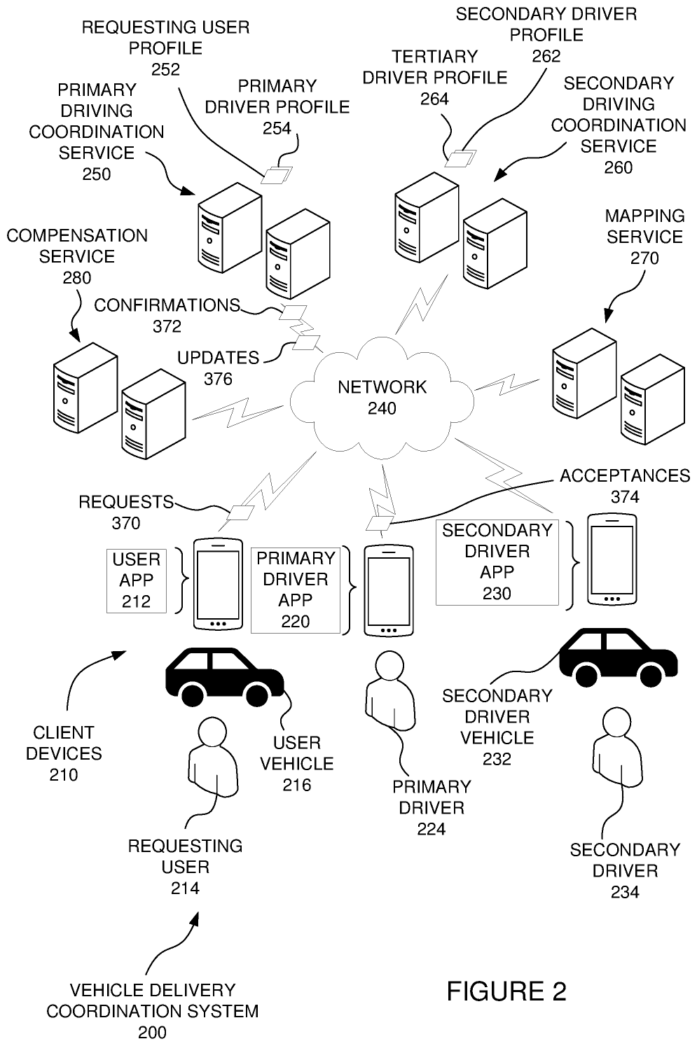

Referring now to FIG. 2, components of a computerized vehicle delivery coordination system 200 will be discussed. Each of the components includes hardware and may also include software. The vehicle delivery coordination system 200 may include less than all the components illustrated in FIG. 2 in some embodiments and may include additional components not illustrated in FIG. 2 in some embodiments. For example, the vehicles illustrated in FIG. 2 may be included in the coordination system itself in some embodiments, such as where computerized components of the vehicles are utilized in the coordination of vehicle deliveries. In other embodiments, the vehicle delivery coordination system 200 may exclude the vehicles themselves, even if the vehicles are used in making deliveries. Additionally, the vehicles may be different types of vehicles. For example, the vehicles may automobiles and/or bicycles. Also, the coordination system is not considered to include the drivers or the requesting user, which use the vehicle delivery coordination system 200. As examples of components including hardware and possibly software, a component of FIG. 2 can be implemented entirely in computer hardware, such as in a system on a chip configuration. Alternatively, a component can be implemented in computer hardware that is configured according to computer software and running the computer software. The components can be distributed across computing machines or grouped into a single computing machine in various ways. For example, a single component may be distributed across multiple different computing machines (e.g., with some of the operations of the component being performed on one or more client computing devices and other operations of the component being performed on one or more machines of a server).

Referring still to FIG. 2, the vehicle delivery coordination system 200 can include client devices 210, such mobile computing devices. For example, the devices may be smartphones or tablet computers. In some embodiments, non-mobile computers such as desktop computers may be used as client devices 210, such as where some user input is provided to a desktop computer, such as via a Web browser application. The vehicle delivery coordination system 200 can include more devices than those illustrated in FIG. 2. The client devices 210 may run computer applications and may receive input from computer users, such as requesting users and/or drivers. As an example, a client device 210 may run a requesting user computer application 212 that can receive user input from and present data to a requesting user 214. The requesting user 214 may provide a user vehicle 216 (such as a vehicle owned, leased, or borrowed by the requesting user 214) for a driving event coordinated by the vehicle delivery coordination system 200. Another client device 210 may run a primary driver computer application 220 that can receive user input from and present data to a primary driver 224. Another client device 210 may run a secondary driver computer application 230 that can receive user input from and present data to a secondary driver 234, which may provide a secondary driver vehicle 232 (such as a vehicle owned, leased, or borrowed by the requesting user 214) for a driving event coordinated by the vehicle delivery coordination system 200. The client devices 210 can communicate with other computing devices through a computer network 240 such as a global computer network, which may include one or more interconnected sub-networks (such as mobile telephone service networks, private networks, etc.). For example, the client devices 210 can communicate with one or more remote computer services (examples of which are discussed below) via the network 240. Such services may also communicate with each other via the network 240.

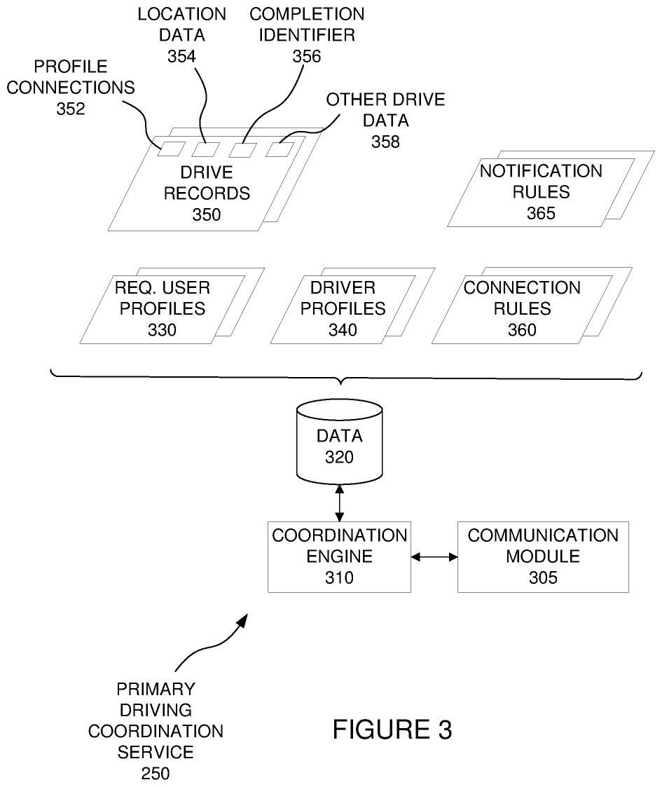

The computer services can include a primary driving coordination service 250, which can perform operations for coordinating primary driving events. For example, the primary driving coordination service can generate and manage connections between a requesting user profile 252 and a primary driver profile 254 for a driving event. The primary driving coordination service may also promote connections with driver profiles via one or more other driving coordination services to facilitate a driving event involving a requesting user profile 252 and a primary driver profile 254. The primary driving coordination service 250 is discussed more below with reference to FIG. 3.

The computer services can also include a secondary driving coordination service 260, which can perform operations for coordinating secondary driving events that can support the primary driving events. For example, the secondary driving coordination service 260 may be an existing driving coordination service that coordinates providing drivers and vehicles to give rides to passenger users (e.g., a taxi service or services that arrange rides by independent contractor-drivers that provide their own vehicles). The secondary driving coordination service 260 can maintain driver profiles, such as a secondary driver profile 262 and a tertiary driver profile 264 and can generate and manage connections between such driver profiles and driving events and/or profiles managed by the primary driving coordination service 250.

The computer services can also include a mapping service 270, which can provide mapping operations that can support the driving coordination operations of the primary driving coordination service 250 and the secondary driving coordination service 260. For example, such a mapping service 270 may provide visual maps of geographic locations and/or routes, and may provide additional data, such as data that indicates geographic distance, natural language directions, and/or estimated driving times along identified routes. The mapping service 270 may provide such mapping operations to the primary driving coordination service 250, the secondary driving coordination service 260 and/or the client devices 210. Indeed, the requesting user application 212, the primary driver application 220, and/or the secondary driver application 230 may include computer code instructions that can interface with the mapping service. As an example, such computer code instructions may be in the form of plugins that can be wrapped within the requesting user application 212, the primary driver application 220, and/or the secondary driver application 230. Moreover, the primary driving coordination service 250 and/or the secondary driving coordination service 260 may interface with the mapping service 270 via one or more application programming interfaces exposed by the mapping service 270.

Additionally, the computer services can include a compensation service 280 that can be invoked by the primary driving coordination service 250 to perform operations in furtherance of providing compensation to user profiles of drivers for associated driving services that are coordinated by the primary driving coordination service 250. For example, the compensation service 280 may perform computerized payment processing operations, which can receive payments from requesting user profiles and/or provide payments to the primary driving coordination service 250, the secondary driving coordination service 260, a profile for the primary driver 224, and/or a profile for the secondary driver 234. In performing such compensation operations, the primary driving service 250 and/or the compensation service 280 can use the connections between the requesting user profile 252, driver profiles such as the primary driver profile 254, and associated river records 350 to perform the operations. For example, such compensation operations may include splitting compensation received from the requesting user profile 254 between the primary driver profile 254, the primary driving coordination service 250, other connected driver profiles in the primary driving coordination service 250, and the secondary driving coordination service 260. In performing compensation operations, the compensation service 280 may interface with the primary driving coordination service 250, the secondary driving coordination service 260, a profile for the primary driver 224, and/or a profile for the secondary driver 234 via one or more application programming interfaces. The compensation service 280 may execute transfers of compensation in one or more of various ways, such as initiating online payment operations, and/or initiating the printing and sending of paper checks.

Referring now to FIG. 3, an example of the primary driving coordination service 250 will be discussed in more detail. The primary driving coordination service 250 can include a communication module 305 that can manage and perform communications between the primary driving coordination service 250 and other computer components such as corresponding client applications and/or other services. The primary driving coordination service 250 can also include a driving coordination engine 310, which can access and operate on data 320 that can be stored in the primary driving coordination service 250. For example, the data 320 may be stored in one or more database tables and/or in one or more other data structures such as in markup language files (e.g., xml files, etc.).

The data 320 can include requesting user profiles 330, which can be user profiles for users that request driving events. For example, the data in a requesting user profile 330 may include credential information (usernames, passwords, etc.); personal information such as name and contact information for a corresponding requesting user 214; payment information such as credit card information or information from an online payment service through which the requesting user profile 330 provides payment; and/or drive history information, such as reviews of the requesting user profile 330 and/or reviews of driver profiles 340 provided by the requesting user profile 330. The data 320 can also include driver profiles 340, which can be user profiles for drivers that are requested to perform driving services during driving events. For example, driver profiles 340 may include credential information (usernames, passwords, etc.); personal information such as name and contact information, and government tax forms for a corresponding driver 224; payment information such as bank account information or information from an online payment service through which the driver profile 340 receives payment; and/or drive history information, such as reviews of the requesting driver profile 340 and/or reviews of requesting user profiles 330 provided by the requesting driver profile 340. In some situations, a user profile may be a requesting user profile 330 for some driving events and a driver profile 340 for other driving events (such as where corresponding user acts as a driver for the service in some driving events and uses the service as a requesting user in other driving events). The coordination engine 310 can receive some of the data for the requesting user profiles 330 and the driver profiles 340 from user input through the communication module 305 and may receive other data for the profiles as it is collected during driving events involving the requesting user profiles 330 and driver profiles 340.

For the requesting user profiles 330, the driver profiles 340, and other sensitive information collected and managed in the vehicle delivery coordination system 200, operations can be performed to protect such data. For example, such operations may include receiving user input to opt into and/or out of the collecting and/or maintaining of sensitive data. Such operations may also include security measures, such as encrypting data that is stored and/or in transit. Additionally, the operations can include restricting computerized and/or physical access to the data and associated computer systems. Also, data that is not needed can be removed from the system and/or anonymized according to a schedule.

The data 320 can also include drive records 350. The drive records 350 can include profile connections 352, which can be connections between requesting user profiles 330 and/or driver profiles 340. Such connections 352 can connect the profiles to each other for a driving event that is represented by the drive record 350 and can also connect the requesting user profiles 330 and driver profiles 340 to the drive records 350 themselves. For example, requesting user profiles 330 and driver profiles 340 can each include an identifier that can be inserted into the drive records 350 by the coordination engine 310 to make a connection between the profile and the drive record 350 and/or between the profile and another profile for a drive event represented by the drive record 350. As another example of a connection, an identifier of the drive record 350 can be included in the requesting user profile 330 and driver profile 340 by the coordination engine 310 to make a connection between the profiles and the drive record 350 and/or between different profiles for a drive event represented by the drive record 350.

The drive records 350 can also include location data 354, which can indicate geographic locations that are part of the driving event, such a street address and/or global positioning coordinates for a starting location and/or an ending location for a driving event, distance driven for a driving event, and/or other geographic location data that describes geographic locations and/or distances for the driving event represented by the drive record. A drive record 350 can also include a completion identifier 356, which can indicate that a driving event represented by the drive record 350 has been indicated to be complete. For example, the coordination engine 310 can insert a completion identifier (such as a single bit data identifier) in response to receiving a user input indication of completion of the driving event, and/or detecting the completion of the driving event (such as by detecting that one or more client devices have arrived at an end location for a driving event, as indicated by global positioning data sent to the communication module 305 by driving coordination applications (such as the requesting user application 212 and/or the primary driver application 220 of FIG. 2), which obtained the global positioning data from location services on the client device(s) 210). The drive records 350 can also include other drive data 358, such as user reviews, indications of the status of the driving event, indications of payment status for the driving event, etc.

The data 320 can also include connection rules 360. The connection rules 360 can dictate one or more operations for the coordination engine 310 to perform in selecting one or more driver profiles 340 for a driving event for a requesting user profile 330. For example, the connection rules 360 may be in the form of computer code that implements a hard-coded formula, which incorporates multiple factors. For example, such code could produce scores for driver profiles 340 whose driver profiles 340 indicate they are available and signed onto the primary driving coordination service 250, and whose driver profiles 340 are currently indicated to be geographically the closest to a starting location specified by requesting user profile 330 (such as the ten closest driver profiles). The scoring can include performing operations such as summing and/or multiplying operations on factors such as geographic distance and/or estimated time from the current geographic location of the driver profile 340 to the starting location, average user review rating for the driver profile 340, amount of time the driver profile 340 has been available without being assigned to a drive record 350, and/or other factors. The operations may include applying different numerical weights to different factors. The weights and/or factors themselves may be adjusted to tune the connection rules 360, and the connection rules 360 may even include rules for tuning the connection rules themselves. Such tuning may be performed by user input and/or using machine learning techniques. In some implementations, different types of data structures and models can be used in the connection rules 360, such as decision trees or neural networks.

Upon selecting a driver profile 340 for a drive record 350 using the connection rules 360, the coordination engine 310 can generate profile connections 352 and include such profile connections 352 in the corresponding drive record 350. For example, including the profile connection 352 may include inserting an entry into a database table or some other data structure for the drive record 350.

The data 320 can also include notification rules 365. The notification rules 365 can dictate when notifications are to be sent. For example, requesting user profiles 330 can be notified when global position system tracking of the driver profile 340 assigned to deliver the requesting user profile's vehicle (as indicated by a connection between the requesting user profile 330 and the driver profile 340 in a drive record 350) arrives at an ending location indicted in the corresponding drive record 350. As another example, a requesting user profile 330 and/or a driver profile 340 may be notified when a driver profile 340 that is assigned to a driving event is approaching a starting location (such where a secondary driver profile is to provide a ride service for a primary driver profile or where a primary driver profile is to provide a drive service for a requesting user profile). Such notification rules 365 can include rules that are applied by the coordination engine 310 to trigger such notifications. The notification rules 365 may also dictate what type of notifications are provided. The notification rules 365 may refer to notification settings in the requesting user profiles 330 and driver profiles 340, which may be set in response to user input received from the corresponding profiles.

The different types of data items discussed herein may be implemented in different types of data structures. Indeed, the data items may be implemented as continuous data structures and/or as distributed data structures. For example, different data items in a drive record 350 may be in a single continuous data location, or they may be distributed among different storage devices, different files, different database tables, or other different data structures.

Also, operations may be distributed differently between different components in the primary driving coordination service 250 and/or in the overall vehicle delivery coordination system 200. For example, operations described herein as being performed by the primary driving coordination service 250 may instead be performed by the requesting user application 212, the primary driver application 220, and/or by a different service that is remote from the client devices 210. Similarly, operations described as being performed by other services such as the mapping service 270 may instead be performed by the primary driving coordination service 250 and/or applications on the client devices 210.

### III. Computerized Vehicle Delivery Coordination Application User Interface

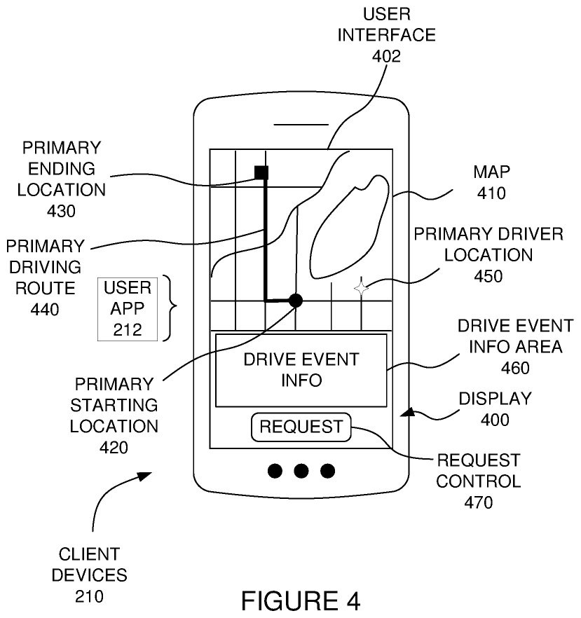

Referring now to FIG. 4 and still to FIGS. 2-3, an example of a graphical user interface will be discussed. In FIG. 4, a client device 210 that is running a requesting user application 212 can include a computer display 400. The display 400 can present an application user interface 402 for the requesting user application 212. The user interface 402 can include a displayed map 410. For example, the map 410 can be provided to the requesting user application 212 by a mapping service 270. As an example, the requesting user application 212 may include a plugin for the mapping service 270, and that plugin can interact with the mapping service 270 and can provide the resulting map 410 for the user interface 402. For example, the requesting user application 212 can provide the plugin with location data for specified locations. Some of that data may be retrieved from the primary driving coordination service 250. Other data may be retrieved from other components, such as from a location service provided by an operating system on the client device 210.

In the illustrated example, the map 410 can display a primary starting location 420 (by displaying a representation of that location on the map 410), which may be a current location of the client device 210 that includes the requesting user application 212, as provided by the location service on the client device 210. The map 410 can also display a primary ending location 430. For example, a requesting user profile 252 that is signed into the requesting user application 212 may have input the primary ending location 430 into the user application 212 by entering a street address for the primary ending location 430. The requesting user application 212 can provide the primary starting location 420 and the primary ending location 430 to a mapping service 270, which can respond by returning data representing a primary driving route 440 between those locations. The mapping service 270 may also return other information such as an estimated amount of time to drive from the primary starting location 420 to the primary ending location 430.

The map 410 may also display one or more driver locations for available driver profiles, such as the primary driver location 450. Data representing the primary driver location 450 may be retrieved from the primary driving coordination service 250 by the requesting user application 212. The requesting user application 212 can continually provide that data to the mapping service 270 to be displayed and updated on the map 410. The primary driving coordination service 250 can continually retrieve the location data for the primary driver location 450 from a corresponding primary driver application 220 running for a primary driver profile 254 on a client device 210 at the primary driver location 450.

The mapping service 270 can provide data indicating an estimated time for driving from the primary driver location 450 to the primary starting location 420. Additionally, if a secondary driver 234 is to provide a ride for a primary driver 224 from the primary driver location 450 to the primary starting location 420, the system can provide an estimate of an amount of time for the secondary driver 234 to arrive at the primary driver location 450. The system can also total an estimated amount of time for the secondary driver 234 to arrive at the primary driver location 450 and bring the primary driver 224 to the primary starting location 420. This can yield a total travel time and/or an estimated arrival time for the primary driver profile 254 to arrive at the primary starting location 420.

A driving event information area 460 can display data describing information about the driving event. Such information can include the estimated total travel time and/or an estimated arrival time for the primary driver profile 254 to arrive at the primary starting location 420. The driving event information area 460 can also display an estimated time for the drive from the primary starting location 420 to the primary ending location 430, and/or an estimated time of arrival at the primary ending location 430. The calculation of the estimated time of arrival at the primary ending location 430 can include adding to a current time an estimated total travel time for the primary driver profile 254 to arrive at the primary starting location 420, and an estimated travel time for the drive from the primary starting location 420 to the primary ending location 430. Such a calculation can be performed by the requesting user application 212 and/or the primary driving coordination service 250.

The user interface 402 can also display a request control 470, which can be a user interface control that can be selected on the display 400 to send a drive request 370 to the primary driving coordination service 250. The drive request 370 can include data that can be included in a drive record 350 for the requested drive event. In some implementations, such data may already be included in a drive record 350, and the drive request 370 can include an identifier that is connected in computer system with the drive record 350.

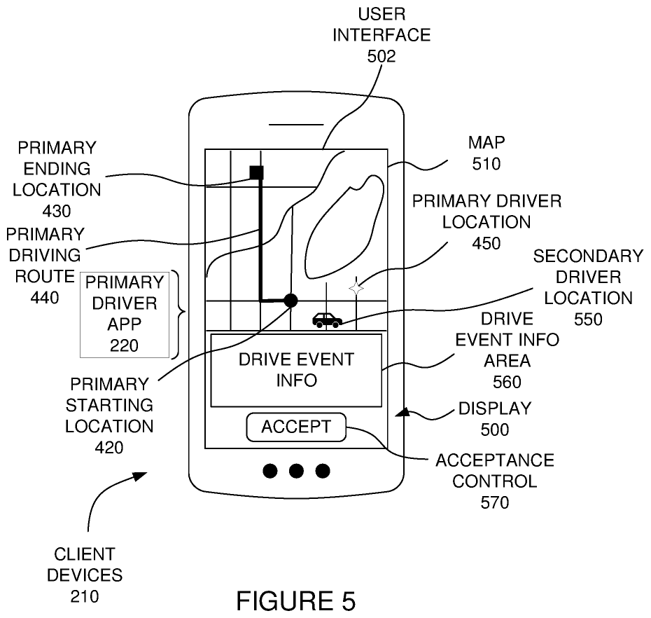

Referring now to FIG. 5 and still to FIGS. 2-4, an example of a client device 210 running a primary driver application 220 is illustrated. In the example, this can be a client device 210 for a primary driver profile 254 that is to be connected with the requesting user profile 252 running on the client device 210 of FIG. 4. The client device 210 can include a computer display 500, which can display a user interface 502 for the primary driver application 220.

The user interface 502 can include a map 510. The map 510 can show the same area as the map 410 of FIG. 4. Indeed, the map 510 can illustrate the primary starting location 420, the primary driving route 440, and the primary ending location 430. In addition, the map 510 can display a secondary driver location 550, which can be a location of a secondary driver profile 262 for delivering the primary driver 224 to the primary starting location 420. The secondary driver profile 262 may be another driver profile from the primary driving coordination service 250, or a driver profile from a different and separate secondary driving coordination service 260. If the secondary driver profile 262 is part of the primary driving coordination service 250, then the location data for presenting the secondary driver location 550 can be retrieved and processed similarly to the data for the primary driver location 450, as discussed above. However, if the secondary driver profile 262 is from the secondary driving coordination service 260, then the location data for the secondary driver location 550 can be retrieved from the secondary driving coordination service 260. For example, such location data may be obtained via the primary driving coordination service 250 and/or via a plugin in the primary driver application that is configured to interact with the secondary driving coordination service 260. In either case, the location data for the secondary driver location 550 can be provided to the mapping service 270, which can provide data for displaying the secondary driver location 550 on the map 510, and data for estimating a driving time for the secondary driver profile 262 to arrive at the primary driver location 450.

The primary driving coordination service 250 may use a portion of the connection rules 360 to determine whether to select the secondary driver profile 262 from the available driver profiles in the primary driving coordination service 250 (such as from available driver profiles that indicate they have their own vehicle available for use), or to request a connection to a secondary driver profile 262 from a secondary driving coordination service 260. For example, the connection rules 360 may dictate that this determination can weigh factors such as a density of driver profiles in the primary driving coordination service 250 that are available in the geographic area, prices available from the secondary driving coordination service 260, and an estimated amount of time to arrive at the geographic pickup location for picking up the primary driver 224. This portion of the connection rules 360 may be in the form of computer code for a simple comparison using scoring techniques, or it may be other types of comparison or raking techniques, such as machine learning techniques which may use machine learning models.

The user interface 502 can include a driving event information area 560, which can include information such as estimated driving times and data regarding the requesting user profile 252 and the secondary driver profile 262. Additionally, the user interface 502 can present an acceptance control 570, which can be a user interface control that can be selected to send an acceptance 374 (see FIG. 2) from the primary driver application 220 to the primary driving coordination service 250. In response to receiving this acceptance 374, the primary driving coordination service 250 can respond by finalizing the generation of the connection between the requesting user profile 252, the primary driver profile 254, the secondary driver profile 262, and the drive record. The primary driving coordination service 250 can also generate one or more confirmations 372 indicating that the connections are finalized and approving the driving event, which can be sent to the requesting user profile 252, the primary driver profile 254, and the secondary driver profile 262. As with other notifications and updates sent to user profiles discussed herein, the confirmations 372 can be sent to and presented by the applications that are dedicated to the coordination of vehicle delivery events through the vehicle delivery coordination system, such as the requesting user application 212, the primary driver application 220, and/or the secondary driver application 230.

The corresponding primary driver 224, secondary driver 234, and requesting user 214 can then proceed with the driving event using the user vehicle 216 and the secondary driver vehicle 232. Specifically, the secondary driver 234 can drive the secondary driver vehicle 232 from the secondary driver location 550 to pick up the primary driver 224 at the primary driver location 450 (also the secondary starting location, or proximate thereto) and can drive the primary driver 224 to the primary starting location 420 (also the secondary ending location, or proximate thereto). The primary driver 224 can then drive the requesting user vehicle 216 to the primary ending location (either with or without the requesting user 214 in the user vehicle 216, depending on the details of the requested driving event). During the driving event, the primary driving coordination service can 250 can send updates 376 to the requesting user profile 252 and driver profile(s) that are connected to the drive record 350 to which the updates pertain. For example, the providing of the updates can include using the connections between the requesting user profile 252, the driver profile(s) and the drive record 350 to collect and process pertinent data regarding the drive event represented by the drive record 350 and send the resulting updates 376 to the connected requesting user profile 252 and driver profile(s). For example, such updates 376 can include data indicating updated geographic locations and/or other status updates of other profiles connected to the drive record 350 (the locations of devices in which those profiles are active, indications of user input to indicate a request, indications of acceptance or completion of a corresponding drive event, etc.). Also, the updates can be presented to the user profiles via the requesting user application 212, the primary driver application 220, and/or the secondary driver application 230, such as by displaying locations on displayed maps and/or presenting audible and/or visual notifications.

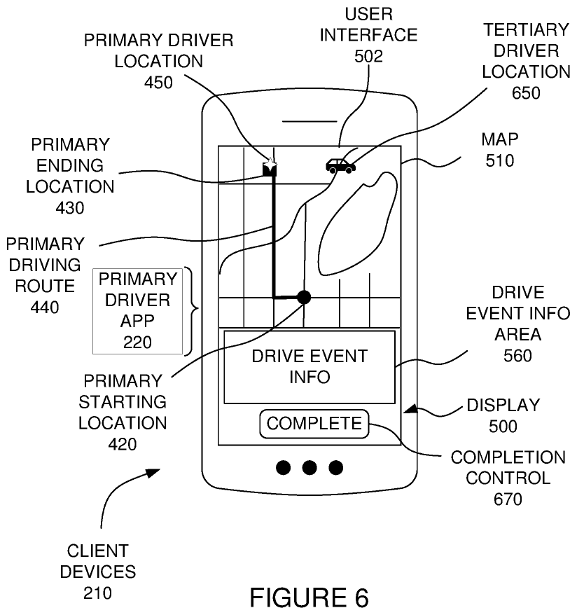

Additionally, referring now to FIG. 6 and still to FIGS. 2-5, the primary driving coordination service 250 can coordinate a connection of a tertiary driver profile 264 with the drive record 350, to coordinate a ride for the primary driver 224 back from the primary ending location 430 (also the tertiary starting location, or proximate thereto) such as back to the primary driver location 450 of FIG. 4 (also the tertiary ending location, or proximate thereto). This coordination with the tertiary driver profile 264 can be done in the same manner as the coordination with the secondary driver profile 262 discussed above. Again, the tertiary driver profile 264 may be a profile from the secondary driving coordination service 260, or it may be a profile from the primary driving coordination service 250. Accordingly, as with the secondary driver location 550 discussed above with reference to FIG. 5, the user interface 502 for the primary driver application 220 can include a display of a tertiary driver location 650, as illustrated in FIG. 6. Similarly, the driving event information area 560 can include information about the tertiary driver profile 264, as with the secondary driver profile 262 discussed above with reference to FIG. 5. The user interface 502 can also display a completion control 670, which can be a user interface control that can be selected to indicate the driving event is complete. In response to selection of the completion control 670, the client device 210 can send a completion notification to the primary driving coordination service 250.

While a specific example scenario is represented in the discussion above, the vehicle delivery coordination system 200 can also perform useful operations in many other scenarios for vehicle delivery coordination where a vehicle for use in the driving event is provided by the requesting user. For example, in some scenarios, a requesting user may request a user for driving for a specified period of time, without a specified ending location or with the ending location being the same as the starting location. For example, a requesting user may submit a request to a driver to drive the requesting user to do some shopping in multiple locations in the requesting user's vehicle for a period of time and then return back to the starting location. In such a scenario, the secondary driver 234 may deliver the primary driver 224 to the specified location, and the tertiary driver may pick up the primary driver 224 at that same location after the primary driving event is complete.

Also, in some scenarios, the primary driver 224 may have access to his/her own vehicle. In such a scenario, where the starting location and ending location of the primary driving event are different, the primary driving coordination service 250 may coordinate with a secondary driver profile 262 to pick up the primary driver 224 at the ending location of the primary driving event and return the primary driver 224 to the starting location of the primary driving event, without involving a tertiary driver profile 264.

As another example, some requests 370 may request multiple driving events by one or more primary drivers 224. For example, a request 370 may request that a user vehicle 216 be taken from a requesting user's place of home or work to an auto shop at 11:00 AM, and that the user vehicle 216 be taken from the auto shop back to the requesting user's place of home or work at 4:00 PM on the same day. Such a request can be coordinated by the vehicle delivery coordination system 200 in the same manner as two separate primary driving events would be coordinated, which may involve coordinating with two different primary driver profiles 254 for the two different primary driving events. The two different primary driving events may be recorded in the primary driving coordination service 250 with two different drive records 350 or a single drive record 350.

### IV. Computerized Vehicle Delivery Coordination Techniques

Several computerized vehicle delivery coordination techniques will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable memory may have computer-executable instructions embodied thereon that, when executed by at least one processor, cause at least one processor to perform the technique. The techniques discussed below may be performed at least in part by hardware logic. Features discussed in each of the techniques below may be combined with each other in any combination not precluded by the discussion herein, including combining features from a technique discussed with reference to one figure in a technique discussed with reference to a different figure. Also, a computer system may include means for performing each of the acts discussed in the context of these techniques, in different combinations.

Techniques discussed herein can include a computer system coordinating user profiles for assigning a primary driver profile with a primary driving event that involves a driver associated with the primary driver profile driving a vehicle that is provided by a user corresponding to a requesting user profile. This coordination can include a computer system assigning a secondary driver profile for a secondary driving event that involves a driver associated with the secondary driver profile driving the primary driver to a starting location for the primary driving event. This coordination can be done via a remote service and/or via applications on client devices that are dedicated to the coordination of user profiles for such driving events. Such applications can include an application running for the requesting user profile, an application running for a primary driver profile, and possibly one or more other applications running for one or more other driver profiles (a secondary driver profile, a tertiary driver profile, etc.). Also, the coordination can include retrieving, generating, and sending data that provides information to the requesting user profile and the driver profiles of details of the driving events via the applications, receiving requests and acceptances from the user profiles via the applications, and receiving input on completions of drive events via the applications. Below are some more detailed discussions of techniques that include at least some of these features.

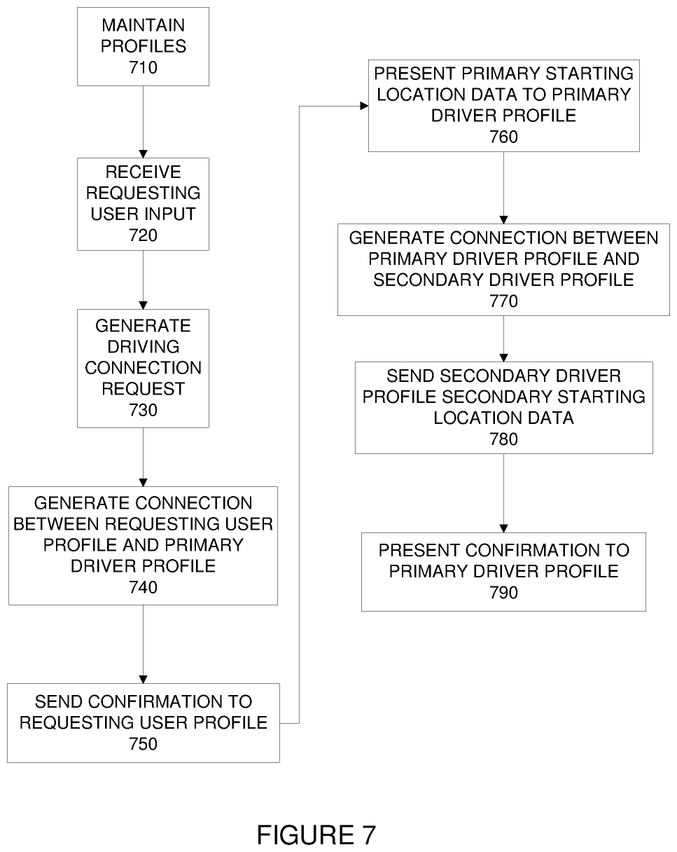

Referring to FIG. 7, a computerized vehicle deliver coordination technique will be discussed. The technique can include maintaining 710 a plurality of computer-readable user profiles and a plurality of computer-readable vehicle driver profiles in a computer system. In response to receiving 720 user input via a user application running for a requesting user profile of the plurality of user profiles in a user computing device in the computer system, the technique can include generating 730 a computer-readable request for a vehicle driving connection to a vehicle driver profile of the plurality of vehicle driver profiles, with the drive request specifying a geographic primary starting location. The technique can further include, in response to the request for the vehicle driving connection, generating 740 a connection between the requesting user profile and a primary driver profile of the plurality of driver profiles in a computer-readable drive record that represents a vehicle delivery event in the computer system. The generating of the connection between the requesting user profile and the primary driver profile can include processing computerized data regarding the primary starting location and a secondary starting location, which can be a geographic location connected with the primary driver profile in the computer system (e.g., an address entered by textual user input and/or a location indicated by a location service (e.g., global positioning system data) of a device running for the primary driver profile). The technique of FIG. 7 can further include sending 750 a computer-readable confirmation to the requesting user profile on the user computing device, with the confirmation to the requesting user profile confirming the connection between the requesting user profile and the primary driver profile. The technique can further include presenting 760 to the primary driver profile computerized data regarding the primary starting location on a primary driver computing device in the computer system.

The technique of FIG. 7 can further include generating 770 a computer-readable connection between the primary driver profile and a computer-readable secondary driver profile in the drive record. The generating 770 of the connection between the primary driver profile and the secondary driver profile can include processing computerized data regarding the secondary starting location and computerized data regarding a geographic location connected with the secondary driver profile in the computer system. The technique can further include sending 780 to the secondary driver profile computerized data regarding the secondary starting location. Additionally, the technique can include presenting 790 on the primary driver computing device a computer-readable confirmation to the primary driver profile confirming the connection between the requesting user profile and the primary driver profile. The presenting 790 may be performed in response to the generating of the connection between the requesting user profile and the primary driver profile. Indeed, all the acts discussed above for the technique of FIG. 7 following the description of the receiving 720 of the requesting user input may be performed in response to that receiving 720 of the requesting user input.

The technique of FIG. 7 can further include detecting via one or both of the primary driver computing device and the user computing device a completion of a driving event represented by the drive record. Also, the technique can include, in response to the detecting of the completion, generating an identifier in the drive record, with the identifier indicating that the driving event is complete.

The primary driver profile and the requesting user profile may be in a computerized driving coordination service that also includes the secondary driver profile. Alternatively, the primary driver profile and the requesting user profile can be in a first computerized driving coordination service that does not include the secondary driver profile, and the secondary driver profile can be in a second computerized driving coordination service that does not include the primary driver profile or the secondary driver profile.

The sending 780 of the computerized data regarding the secondary starting location to the secondary driver profile can include sending the computerized data regarding the secondary starting location from the first computerized driving coordination service to the second computerized driving coordination service.

The request for the vehicle driving connection can be termed a primary request for a primary vehicle driving connection. Also, the generating 770 of the connection between the primary driver profile and the secondary driver profile can include sending a secondary request for a secondary vehicle driving connection from the first driving coordination service to the second driving coordination service, with the secondary request including computerized data indicating the primary starting location and the secondary starting location. Also, the generating 770 of the connection between the primary driver profile and the secondary driver profile can include receiving from the second driving coordination service a secondary confirmation of a data entry in the second driving coordination service confirming an acceptance of the secondary request, wherein the generating of the connection between the primary driver profile and the secondary driver profile can proceed in the first driving coordination service in response to the request.

The technique of FIG. 7 can further include retrieving computer-readable global positioning system coordinates from a location service on the user computing device, wherein the computerized data regarding the primary starting location can include the global positioning system coordinates from the user computing device.

The technique of FIG. 7 may further include retrieving computer-readable global positioning system coordinates from a location service on the primary driver computing device. The computerized data regarding the secondary starting location can include the global positioning system coordinates from the primary driver computing device.

The technique of FIG. 7 may further include tracking a current geographic position of a secondary driver computing device connected with the secondary driver profile as the secondary driver computing device approaches the secondary starting location. The technique may also include presenting a representation of the current tracked geographic position (which may include some time lag) of the secondary driver computing device on the primary driver computing device as the secondary driver computing device approaches the secondary starting location.

The technique of FIG. 7 may further include tracking a current geographic position of the primary driver computing device as the primary driver computing device approaches the primary starting location. Also, the technique may include presenting a representation of the tracked current geographic position of the primary driver computing device on the user computing device as the primary driver computing device approaches the primary starting location.

The primary driver profile and the requesting user profile can be in a computerized first driving coordination service. The generating of the connection between the primary driver profile and the secondary driver profile in the drive record can include determining via a computerized selection process whether to select a driver profile from the first driving coordination service or a driver profile from a second driving coordination service that is different from the first driving coordination service.

The drive record can indicate a primary ending location connected to the primary driver profile and the requesting user profile. The technique of FIG. 7 can further include generating a computer-readable connection between the primary driver profile and a computer-readable tertiary driver profile in the drive record. The generating of the connection between the primary driver profile and the tertiary driver profile can include processing computerized data regarding a geographic tertiary starting location, with the tertiary starting location being proximate the primary ending location. A location may be considered to be proximate to another location if it is the same location, if one location is derived from the other location in a manner that indicates they are to be the same location (such as by converting global positioning system coordinates to nearby street addresses), or if it would be reasonable to walk between the locations in a short amount of time, such as within two-hundred meters of each other. This can allow for variations in global positioning coordinates and for locations that are short distances (such as a block or two away) from each other if such locations are convenient (such as where different locations may be more convenient pick up or drop off because of a one-way-street system, because of different locations for passenger arrivals and departures at airports, etc.). Also, locations can be considered to be the same location if they are approximately the same location. For example, global positioning coordinates may be converted to street addresses proximate to the locations indicated by the global positioning coordinates and still be considered to be the same location.

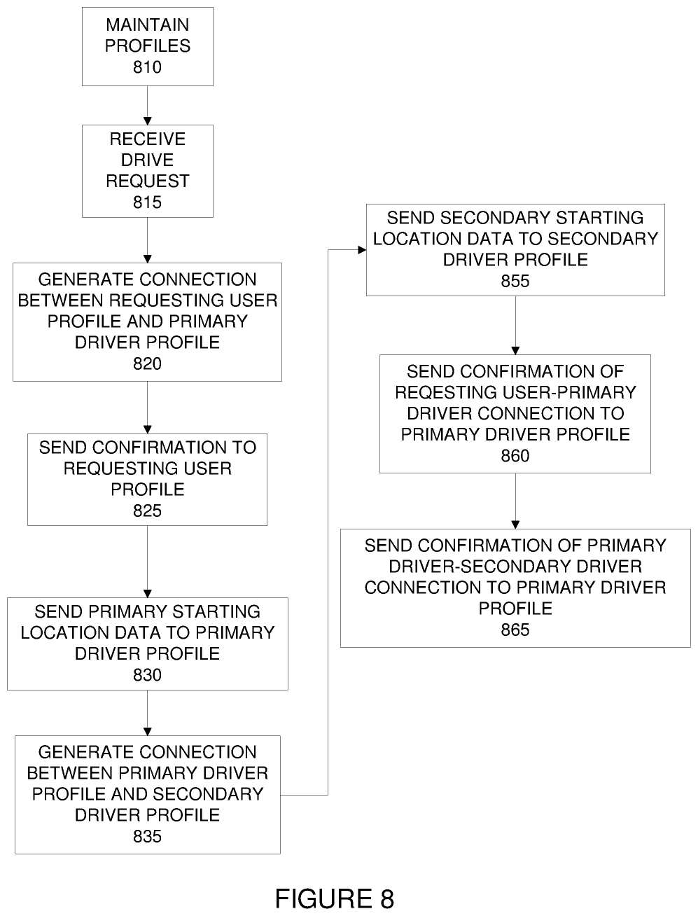

Referring now to FIG. 8, another computerized vehicle delivery coordination technique will be discussed. The technique can include maintaining 810 a plurality of computer-readable user profiles and a plurality of computer-readable vehicle driver profiles. The technique can also include receiving 815 a computer-readable drive request from a user profile of the plurality of user profiles for a vehicle driving connection to a vehicle driver profile of the plurality of vehicle driver profiles, with the drive request specifying a geographic primary starting location. In response to the receiving 815 of the request, the technique can include generating 820 a computer-readable connection between the requesting user profile and a primary driver profile of the plurality of driver profiles. The generating 820 of the connection between the requesting user profile and the primary driver profile can include processing computerized data regarding the primary starting location and a secondary starting location, wherein the secondary starting location can be a geographic location connected with the primary driver profile in the computer system. The technique can further include sending 825 a computer-readable confirmation to the requesting user profile confirming the connection between the requesting user profile and the primary driver profile. The technique can also include sending 830 to the primary driver profile computerized data regarding the primary starting location.

The technique can also include, in response to the generating of the connection between the requesting user profile and the primary driver profile, generating 835 a computer-readable connection between the primary driver profile and a computer-readable secondary driver profile. The generating 835 of the connection between the primary driver profile and the secondary driver profile can include processing computerized data regarding the secondary starting location and computerized data regarding a geographic location connected with the secondary driver profile in the computer system. The technique can also include sending 855 to the secondary driver profile computerized data regarding the secondary starting location. Moreover, the technique can include, in response to the generating of the connection between the requesting user profile and the primary driver profile, sending 860 a computer-readable confirmation to the primary driver profile confirming the connection between the requesting user profile and the primary driver profile. Additionally, the technique can include, in response to the generating of the connection between the primary driver profile and the secondary driver profile, sending 865 a computer-readable confirmation to the primary driver profile confirming the connection between the primary driver profile and the secondary driver profile.

The technique of FIG. 8 can further include driving, via a secondary driver indicated in the secondary driver profile, a secondary vehicle to the secondary starting location and driving a primary driver indicated in the primary driver profile from the secondary starting location to the primary starting location in the secondary vehicle. Additionally, the technique can include driving, via the primary driver indicated in the primary driver profile, a vehicle indicated by the requesting user profile from the primary starting location to a geographic location that is different from the primary starting location.

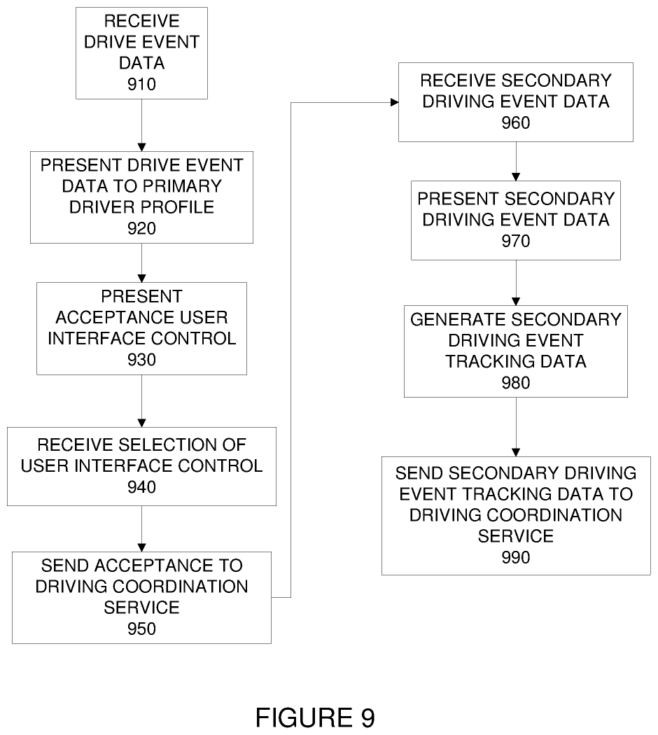

Referring now to FIG. 9, another computerized vehicle delivery coordination technique will be discussed. One or more of the acts in the technique of FIG. 9 may be performed via a computer application running for a primary computer-readable profile on a primary driver computing device. The technique can include receiving 910 computerized data regarding a driving event from a computerized driving coordination service, with the computerized data regarding the driving event including a primary starting location. The technique can further include presenting 920 the computerized data regarding the driving event to the primary driver profile. The technique can also include presenting 930 an acceptance user interface control that is selectable to accept a computerized connection of the primary driver profile with the driving event. For example, the user interface control may be a visual control on a display (such as a button) or some other type of control, such as a natural language prompt provided by a natural language processing system that calls for natural language input as a response. The technique of FIG. 9 can further include receiving 940 a user input selection of the acceptance user interface control. In response to the selection of the acceptance user interface control, the technique can include sending 950 to the computerized driving coordination service acceptance data that is responsive to the receiving of the computerized data regarding the driving event. In addition, the technique can include receiving 960 for the primary driver profile computerized data regarding a secondary driving event that is linked in the application with the primary driving event. The computerized data regarding the secondary driving event can include a geographic secondary starting location and a geographic secondary ending location, wherein the secondary ending location can be proximate to the primary starting location.

The technique of FIG. 9 can further include presenting 970 the computerized data regarding the secondary driving event to the primary driver profile. Also, the technique can include generating 980 secondary driving event tracking data, with the secondary driving event tracking data indicating a geographic current location of the primary driver computing device as the indicated current location of the primary driver computing device moves between the secondary starting location and the primary starting location. Additionally, the technique can include sending 990 the secondary driving event tracking data to the computerized driving coordination service.

The technique of FIG. 9 can further include presenting an indicator of a tracked position of a computer-readable secondary driver profile as the position of the secondary driver profile approaches the secondary starting position. The presenting of the tracked position of the secondary driver profile can be displayed on a map that is presented within a user interface of the application.

The driving coordination service can be termed a first driving coordination service. The presenting of the indicator of the tracked position of the secondary driver profile can include receiving geographic position tracking data from a second driving coordination service that is separate from the first driving coordination service.

The technique of FIG. 9 can further include receiving a completion user input via the application, with the completion user input indicating a completion of the primary driving event. In response, the technique can include sending a completion transmittal to the driving coordination service, with the completion transmittal being computer-readable data comprising an indication that the primary driving event is complete.

The presenting 970 of the computerized data regarding the secondary driving event can include presenting data that describes a secondary driving profile that is connected with the secondary driving event.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A computer system comprising:
at least one processor; and
memory comprising instructions stored thereon that when executed by at least one processor cause at least one processor to perform acts comprising:
maintaining a plurality of computer-readable user profiles and a plurality of computer-readable vehicle driver profiles in the computer system;
in response to receiving user input via a user application running for a requesting user profile of the plurality of user profiles in a user computing device in the computer system, generating a computer-readable request for a vehicle driving connection to a vehicle driver profile of the plurality of vehicle driver profiles, with the drive request specifying a geographic primary starting location;
in response to the request for the vehicle driving connection, generating, via the computer system, a computer-readable connection between the requesting user profile and a primary driver profile of the plurality of driver profiles in a computer-readable drive record that represents a vehicle delivery event in the computer system, wherein the generating of the connection between the requesting user profile and the primary driver profile comprises processing computerized data regarding the primary starting location and a secondary starting location, which is a geographic location connected with the primary driver profile in the computer system;
sending, via the computer system, a computer-readable confirmation to the requesting user profile on the user computing device, with the confirmation to the requesting user profile confirming the connection between the requesting user profile and the primary driver profile;
via the computer system, presenting to the primary driver profile computerized data regarding the primary starting location on a primary driver computing device in the computer system;
in response to the generating of the connection between the requesting user profile and the primary driver profile, generating, via the computer system, a computer-readable connection between the primary driver profile and a computer-readable secondary driver profile in the drive record, wherein the generating of the connection between the primary driver profile and the secondary driver profile comprises processing computerized data regarding the secondary starting location and computerized data regarding a geographic location connected with the secondary driver profile in the computer system;
via the computer system, sending to the secondary driver profile computerized data regarding the secondary starting location; and
in response to the generating of the connection between the requesting user profile and the primary driver profile, presenting on the primary driver computing device a computer-readable confirmation to the primary driver profile confirming the connection between the requesting user profile and the primary driver profile.

2. The computer system of claim 1, wherein the acts further comprise:
detecting via one or both of the primary driver computing device and the user computing device a completion of a driving event represented by the drive record, and
in response to the detecting of the completion, generating an identifier in the drive record, with the identifier indicating that the driving event is complete.

3. The computer system of claim 1, wherein the primary driver profile and the requesting user profile are in a computerized driving coordination service that also includes the secondary driver profile.

4. The computer system of claim 1, the primary driver profile and the requesting user profile are in a first computerized driving coordination service that does not include the secondary driver profile, and wherein the secondary driver profile is in a second computerized driving coordination service that does not include the primary driver profile or the secondary driver profile.

5. The computer system of claim 4, wherein the sending to the secondary driver profile the computerized data regarding the secondary starting location comprises sending the computerized data regarding the secondary starting location from the first computerized driving coordination service to the second computerized driving coordination service.

6. The computer system of claim 4, wherein the request for the vehicle driving connection is a primary request for a primary vehicle driving connection and wherein the generating of the connection between the primary driver profile and the secondary driver profile comprises:
sending a secondary request for a secondary vehicle driving connection from the first driving coordination service to the second driving coordination service, with the secondary request comprising computerized data indicating the primary starting location and the secondary starting location; and
receiving from the second driving coordination service a secondary confirmation of a data entry in the second driving coordination service confirming an acceptance of the secondary request, wherein the generating of the connection between the primary driver profile and the secondary driver profile proceeds in the first driving coordination service in response to the request.

7. The computer system of claim 1, wherein the acts further comprise retrieving computer-readable global positioning system coordinates from a location service on the user computing device, and wherein the computerized data regarding the primary starting location comprises the global positioning system coordinates from the user computing device.

8. The computer system of claim 1, wherein the acts further comprise retrieving computer-readable global positioning system coordinates from a location service on the primary driver computing device, and wherein the computerized data regarding the secondary starting location comprises the global positioning system coordinates from the primary driver computing device.

9. The computer system of claim 1, wherein the acts further comprise:
tracking a current geographic position of a secondary driver computing device connected with the secondary driver profile as the secondary driver computing device approaches the secondary starting location; and
presenting a representation of the current tracked geographic position of the secondary driver computing device on the primary driver computing device as the secondary driver computing device approaches the secondary starting location.

10. The computer system of claim 9, wherein the acts further comprise:
tracking a current geographic position of the primary driver computing device as the primary driver computing device approaches the primary starting location; and
presenting a representation of the tracked current geographic position of the primary driver computing device on the user computing device as the primary driver computing device approaches the primary starting location.

11. The computer system of claim 1, wherein the primary driver profile and the requesting user profile are in a computerized first driving coordination service, and wherein the generating of the connection between the primary driver profile and the secondary driver profile in the drive record comprises determining via a computerized selection process whether to select a driver profile from the first driving coordination service or a driver profile from a second driving coordination service that is different from the first driving coordination service.

12. The computer system of claim 1, wherein the drive record indicates a primary ending location connected to the primary driver profile and the requesting user profile, wherein the acts further comprise generating, via the computer system, a computer-readable connection between the primary driver profile and a computer-readable tertiary driver profile in the drive record, wherein the generating of the connection between the primary driver profile and the tertiary driver profile comprises processing computerized data regarding a geographic tertiary starting location, with the tertiary starting location being proximate the primary ending location.

13. A computer-implemented method, comprising:
maintaining, via a computer system, a plurality of computer-readable user profiles and a plurality of computer-readable vehicle driver profiles;
receiving, via the computer system, a computer-readable drive request from a user profile of the plurality of user profiles for a vehicle driving connection to a vehicle driver profile of the plurality of vehicle driver profiles, with the drive request specifying a geographic primary starting location;
in response to the receiving of the request, generating, via the computer system, a computer-readable connection between the requesting user profile and a primary driver profile of the plurality of driver profiles, wherein the generating of the connection between the requesting user profile and the primary driver profile comprises processing computerized data regarding the primary starting location and a secondary starting location, wherein the secondary starting location is a geographic location connected with the primary driver profile in the computer system;
sending, via the computer system, a computer-readable confirmation to the requesting user profile confirming the connection between the requesting user profile and the primary driver profile;
via the computer system, sending to the primary driver profile computerized data regarding the primary starting location;
in response to the generating of the connection between the requesting user profile and the primary driver profile, generating, via the computer system, a computer-readable connection between the primary driver profile and a computer-readable secondary driver profile, wherein the generating of the connection between the primary driver profile and the secondary driver profile comprises processing computerized data regarding the secondary starting location and computerized data regarding a geographic location connected with the secondary driver profile in the computer system;
via the computer system, sending to the secondary driver profile computerized data regarding the secondary starting location;
sending, via the computer system, a computer-readable confirmation to the primary driver profile confirming the connection between the requesting user profile and the primary driver profile; and
in response to the generating of the connection between the primary driver profile and the secondary driver profile, sending, via the computer system, a computer-readable confirmation to the primary driver profile confirming the connection between the primary driver profile and the secondary driver profile.

14. The method of claim 13, wherein the method further comprises:
driving, via a secondary driver indicated in the secondary driver profile, a secondary vehicle to the secondary starting location and driving a primary driver indicated in the primary driver profile from the secondary starting location to the primary starting location in the secondary vehicle; and
driving, via the primary driver indicated in the primary driver profile, a vehicle indicated by the requesting user profile from the primary starting location to a geographic location that is different from the primary starting location.

15. One or more computer-readable memory having computer-executable instructions embodied thereon that, when executed by at least one processor, cause at least one processor to perform acts comprising:
receiving, via a computer application running for a primary computer-readable profile on a primary driver computing device, computerized data regarding a driving event from a computerized driving coordination service, with the computerized data regarding the driving event comprising a primary starting location;
presenting, via the computer application, the computerized data regarding the driving event to the primary driver profile;
presenting, via the computer application, an acceptance user interface control that is selectable to accept a computerized connection of the primary driver profile with the driving event;
receiving, via the computer application, a user input selection of the acceptance user interface control;
in response to the selection of the acceptance user interface control, sending to the computerized driving coordination service, via the computer application, acceptance data that is responsive to the receiving of the computerized data regarding the driving event;
receiving for the primary driver profile, via the computer application, computerized data regarding a secondary driving event that is linked in the application with the primary driving event, with the computerized data regarding the secondary driving event comprising a geographic secondary starting location and a geographic secondary ending location, wherein the secondary ending location is proximate to the primary starting location;
presenting, via the computer application, the computerized data regarding the secondary driving event to the primary driver profile;
generating secondary driving event tracking data, via the application, with the secondary driving event tracking data indicating a geographic current location of the primary driver computing device as the indicated current location of the primary driver computing device moves between the secondary starting location and the primary starting location; and
sending the secondary driving event tracking data to the computerized driving coordination service.

16. The one or more computer-readable memory of claim 15, wherein the acts further comprise presenting, via the application, an indicator of a tracked position of a computer-readable secondary driver profile as the position of the secondary driver profile approaches the secondary starting position.

17. The one or more computer-readable memory of claim 16, wherein the presenting of the tracked position of the secondary driver profile is displayed on a map that is presented within a user interface of the application.

18. The one or more computer-readable memory of claim 16, wherein the driving coordination service is a first driving coordination service, and wherein the presenting of the indicator of the tracked position of the secondary driver profile comprises receiving geographic position tracking data from a second driving coordination service that is separate from the first driving coordination service.

19. The one or more computer-readable memory of claim 15, wherein the acts further comprise:
receiving a completion user input via the application, with the completion user input indicating a completion of the primary driving event; and
in response to the receiving of the completion user input, sending a completion transmittal to the driving coordination service, with the completion transmittal being computer-readable data comprising an indication that the primary driving event is complete.

20. The one or more computer-readable memory of claim 15, wherein the presenting of the computerized data regarding the secondary driving event comprises presenting data that describes a secondary driving profile that is connected with the secondary driving event.
